(19) United States
(12) Patent Application Publication
(10) Pub. No.: US 2013/0122517 A1
(43) Pub. Date: May 16, 2013

(54) METHOD OF PERFORMING AN ASSAY

(71) Applicants: Tanja Henzler, Mannheim (DE); Karl Holschuh, Seeheim-Jugenheim (DE); Johann Bauer, Darmstadt (DE); Thomas Herget, Darmstadt (DE); Michael Hartmann, Schopfloch (DE); Oliver Poetz, Tuebingen (DE); Thomas Joos, Tuebingen (DE)

(72) Inventors: Tanja Henzler, Mannheim (DE); Karl Holschuh, Seeheim-Jugenheim (DE); Johann Bauer, Darmstadt (DE); Thomas Herget, Darmstadt (DE); Michael Hartmann, Schopfloch (DE); Oliver Poetz, Tuebingen (DE); Thomas Joos, Tuebingen (DE)

(73) Assignee: MERCK PATENT GMBH, Darmstadt (DE)

(21) Appl. No.: 13/811,743

(22) PCT Filed: Jun. 30, 2011
(86) PCT No.: PCT/EP2011/003242

§ 371 Date: Jan. 23, 2013

(30) Foreign Application Priority Data
Jul. 23, 2010 (EP) 10007645.4

(51) Int. Cl. G01N 21/64

(52) U.S. Cl. CPC G01N 21/6428
USPC 435/7.1; 436/501

(57) ABSTRACT

The present invention relates to a method and kit for performing assays like immunoassays. The assays are performed by using two different types of magnetic beads.

The present invention relates to a method and a kit for performing assays like immunoassays.

### BACKGROUND OF THE INVENTION

Immunoassays are based on the reaction of an analyte or antigen (Ag) with a selective antibody (Ab) to give a product (Ag—Ab) that can be measured. Several types of labels have been used in immunoassays, including radioactivity, enzymes, fluorescence, luminescence and phosphorescence.

The presence and concentration of multiple specific analytes such as, but not limited to, DNA, RNA, metabolites and proteins, in a biological sample containing one or more other molecules can be determined during a single experiment by using the so-called multiplexed microarray techniques.

One technique for performing multiplexed immunoassays is the Luminex xMAP® technology which is based on beads which are color coded with two different fluorescent dyes. The combination of different concentrations of these fluorescent dyes ends up in more than 100 different bead types. A third fluorescent dye can be used as reporter. The reporter fluorescent is an indicator for a positive reaction on the bead surface.

For performing a sandwich immuno assay in a multiplex fashion using the Luminex xMAP® technology the capture antibody specific for an analyte is coupled to one type of fluorescent-labeled beads. The analyte captured by the bead-coupled antibody can be detected by a second antibody whereby the second antibody directly or indirectly produces a detection signal. In consequence, with this type of multiplexed assay format several conventional ELISA assays can be done in one well in parallel.

Typical protocols for sandwich immuno assays utilizing the Luminex xMAP® technology need more than 4 hours working time depending on the long incubation steps to be performed for the binding of the detection antibody.

Consequently, there exists a clear need for an overall shorter protocol with shorter incubation times to save time and to get important results faster.

### BRIEF DESCRIPTION OF THE INVENTION

It has been found that the working times for bead based assays can be significantly reduced if not only the capture antibody or capture group specific for an analyte is coupled to magnetic beads but also the detection antibody or detection group is coupled to a magnetic bead.

If a magnetic field is applied when incubating the capture antibody (coupled to a magnetic bead), the sample solution and the detection antibody (coupled to a magnetic bead), the binding of the antibodies to the analyte is accelerated and thus the working time is reduced.

The present invention is consequently directed to a method of detecting an analyte by
a) providing a sample solution, magnetic capture beads carrying capture groups and magnetic detection beads carrying detection groups, whereby typically but not necessarily the capture groups and the detection groups are able to bind to the same analyte;
b) incubating the sample solution with the capture beads and the detection beads whereby at least during a part of the incubation time a magnetic field is applied;
c) detecting the presence of analytes which are directly or indirectly bound to at least one capture bead and at least one detection bead.

In a preferred embodiment, the capture groups and the detection groups are antibodies.

In one embodiment, step b) is performed by

b1) incubating the sample solution with the detection beads so that the analyte is bound to the detection beads

b2) removing the detection beads from the mixture of b1) and incubating the detection beads comprising the bound analyte with the capture beads whereby at least during a part of the incubation time a magnetic field is applied.

In a preferred embodiment, in step b) the capture beads and the detection beads are simultaneously incubated with the sample solution.

Simultaneously means that both, capture beads and the detection beads, are incubated together with the sample solution. Typically, for simultaneous incubation, capture beads and the detection beads are added to the sample solution within a time range of not more than 5 to 10 minutes.

In another preferred embodiment, in step a) more than one type of magnetic capture beads are used whereby each type of magnetic capture bead binds to another analyte.

In another preferred embodiment the magnetic field is applied by dipping a magnetic stick in the sample solution.

In another preferred embodiment, step c) is done by flow cytometry analysis.

In one embodiment the capture beads are ferromagnetic beads which are labelled with two different fluorescent dyes.

The present invention is also directed to a kit comprising at least a set comprising magnetic capture beads carrying capture groups and magnetic detection beads carrying detection groups whereby the capture groups and the detection groups are able to bind directly or indirectly to the same analyte.

In a preferred embodiment the kit comprises more than one set comprising magnetic capture beads carrying capture groups and magnetic detection beads carrying detection groups whereby the capture groups and the detection groups of different sets bind directly or indirectly to different analytes.

### DETAILED DESCRIPTION OF THE INVENTION

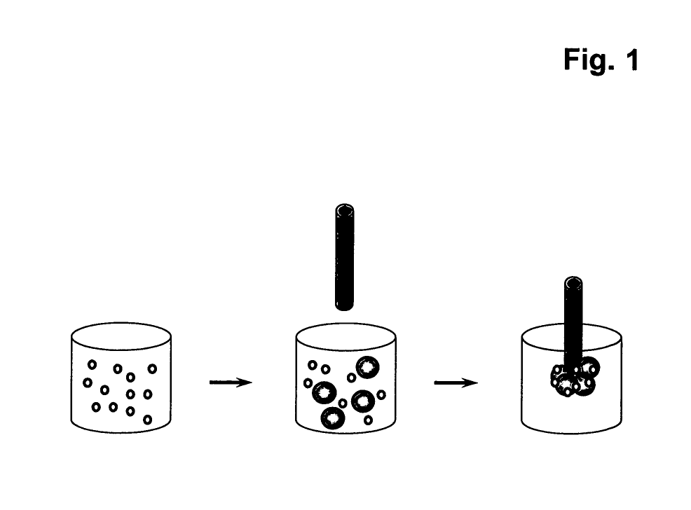

FIG. 1 schematically shows one possibility of how the method according to the present invention can be performed.

Detection beads, e.g. magnetic and fluorescent nanoBeads (25 nm), that are coated with an analyte specific antibody, are incubated with a sample solution for typically <1 h. Then the detection beads are collected with a magnetic bead handler and transferred to a second solution with magnetic capture beads (6.5 μm) which are coated with analyte specific antibody as well. The binding of the analyte (which is already bound to the detection beads) to the capture beads is magnetically assisted and done in less than 10 minutes. The read out step is not shown.

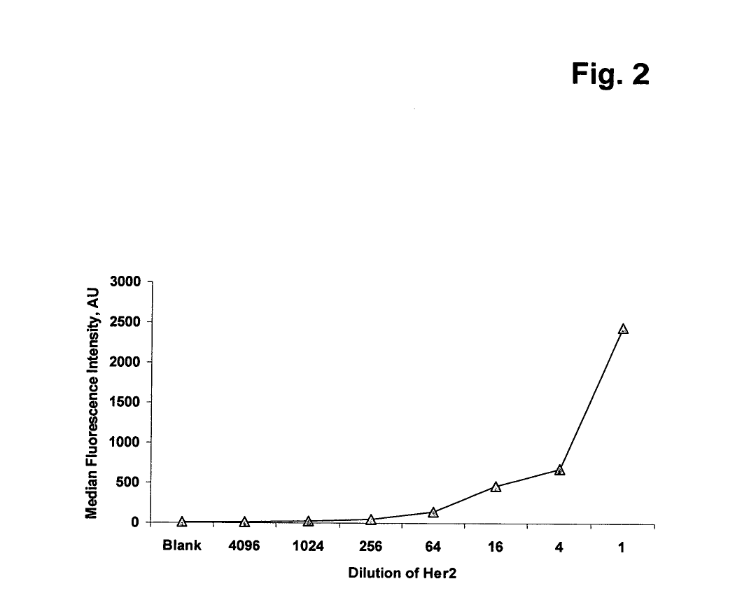

FIG. 2 shows the curve of the Her2 detection according to Example 2.

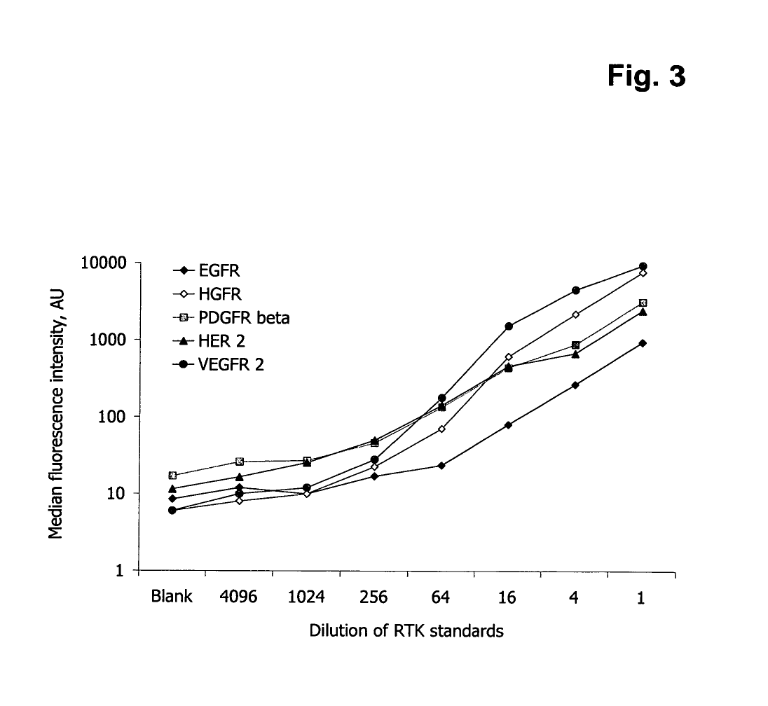

FIG. 3 shows the results of the multiplex detection of 5 RTKs according to Example 3.

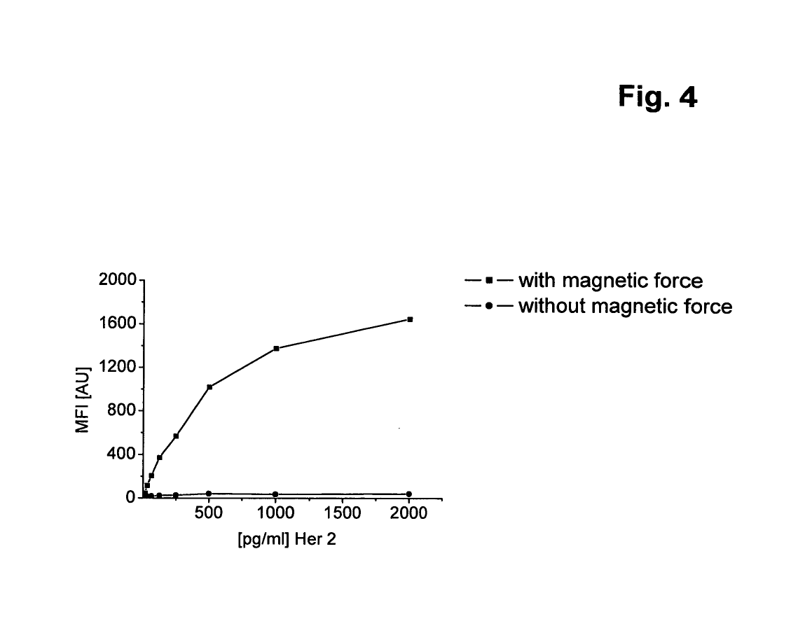

FIG. 4 shows the comparison of assay performance with and without the application of a magnetic field. Details can be found in Example 4.

Before describing the present invention in detail, it is to be understood that this invention is not limited to specific compositions or process steps, as such may vary. It must be noted that, as used in this specification and the appended claims, the singular form “a”, “an” and “the” include plural referents unless the context clearly dictates otherwise. Thus, for example, reference to “a ligand” includes a plurality of ligands and reference to “an antibody” includes a plurality of antibodies and the like.

Unless defined otherwise, all technical and scientific terms used herein have the same meaning as commonly understood by one of ordinary skill in the art to which this invention is related. The following terms are defined for purposes of the invention as described herein.

A bead based assay is an assay to detect or measure the presence of an analyte in a sample, whereby the sample is incubated with at least one type of beads carrying capture groups or detection groups.

As used herein, and unless stated otherwise, the term “analyte” designates a substance, compound, or composition fixed as goal or point of analysis, that means whose presence, absence, amount, or concentration in a sample or specimen is to be detected or determined. It includes molecular compounds such as but not limited to nucleic acids and related compounds (e.g. DNAs, RNAs, oligonucleotides or analogs thereof, PCR products, genomic DNA, bacterial artificial chromosomes, plasmids and the likes), proteins and related compounds (e.g. polypeptides, monoclonal antibodies, receptors, transcription factors, and the likes), antigens, ligands, haptens, carbohydrates and related compounds (e.g. polysacharides, oligosacharides and the likes), metabolites, cellular organelles, intact cells, and the likes.

As used herein, and unless stated otherwise, the term “sample” refers to any composition or mixture that contains a target “analyte”. Samples may be derived from biological or other sources. Biological sources include eukaryotic and prokaryotic sources, such as plant and animal cells, tissues and organs. The sample may also include diluents, buffers, detergents, and contaminating species, debris and the like that are found mixed with the target analyte.

As used herein, and unless stated otherwise, the term “capture group” designates an agent able to interact specifically with an “analyte” that is part of the sample or with an interfering substance that is able to specifically interact with an analyte. Any reagent that possesses a high degree of specificity and affinity for the analyte or the interfering substance can be used as capture group. For example, a specific receptor or a ligand can be used for the purpose, and such capture groups are well within the scope of the instant invention. It also includes molecular compounds such as but not limited to nucleic acids and related compounds (e.g. DNAs, RNAs, oligonucleotides or analogs thereof, PCR products, genomic DNA, bacterial artificial chromosomes, plasmids and the likes), proteins and related compounds (e.g. polypeptides, monoclonal antibodies, receptors, transcription factors, and the likes), antigens, ligands, haptens, carbohydrates and related compounds (e.g. polysacharides, oligosacharides and the likes), metabolites, cellular organelles, intact cells, and the likes.

A bead carrying one or more capture groups is called capture bead. “A bead carrying one or more capture groups” means that one or more capture groups are conjugated to the bead. The capture bead might carry one or more detectable labels and/or might be size coded.

As used herein, the term “conjugated” refers to stable attachment, typically by virtue of a chemical interaction, including ionic and/or covalent attachment. Among the conjugation means are streptavidin- or avidin- to biotin interaction; hydrophobic interaction; polar interactions, such as “wetting” associations between two polar surfaces or between oligo/polyethylene glycol; formation of a covalent bond, such as an amide bond, disulfide bond, thioether bond, or via crosslinking agents.

As used herein, and unless stated otherwise, the term “detection group” designates an agent able to interact specifically with an “analyte” that is part of the sample or with an interfering substance that is able to specifically interact with an analyte. Any reagent that possesses a high degree of specificity and affinity for the analyte or the interfering substance can be used as detection group. For example, a specific receptor or a ligand can be used for the purpose, and such detection groups are well within the scope of the instant invention. It also includes molecular compounds such as but not limited to nucleic acids and related compounds (e.g. DNAs, RNAs, oligonucleotides or analogs thereof, PCR products, genomic DNA, bacterial artificial chromosomes, plasmids and the likes), proteins and related compounds (e.g. polypeptides, monoclonal antibodies, receptors, transcription factors, and the likes), antigens, ligands, haptens, carbohydrates and related compounds (e.g. polysacharides, oligosacharides and the likes), metabolites, cellular organelles, intact cells, and the likes.

As used herein, the term “label” refers to a composition detectable by spectroscopic, fluorimetric, photochemical, biochemical, immunochemical, enzymatic, chemical, or other physical means. For example, useful labels include such as but not limited to luminescent molecules (e.g. fluorescent agents, phosphorescent agents, chemiluminescent agents, bioluminescent agents and the likes), coloured molecules, molecules producing colours upon reaction, enzymes, magnetic beads, radioisotopes, specifically bondable ligands, microbubbles detectable by sonic resonance, biotin, digoxigenin, or haptens and proteins or other entities which can be made detectable, e.g., by incorporating a radiolabel into a peptide or used to detect antibodies specifically reactive with an antigen, and the likes.

As used herein, to “specifically interact” with an analyte refers to a binding reaction that is determinative of the presence, e.g., of the analyte in a heterogeneous population of polypeptides and other biologics. Thus when a component specific to a target the analyte binds to that analyte, it binds to that particular analyte preferentially out of a complex mixture. For example, it can bind at least two times the background, generally 10 to 100 times background, and does not substantially bind in significant amounts to other proteins or components in the sample.

As used herein, and unless stated otherwise, a bead carrying one or more detection groups is called “detection bead”. “A bead carrying one or more detection groups” means that one or more detection groups are conjugated to the bead.

According to the present invention, a detection bead also comprises a means for generating a detectable response. Typically the detectable response is generated by one or more labels. The detectable response can also be generated by the specific size of the detection bead. That means instead of or in addition to using detection beads that are coded with one or more labels, according to the present invention, one can also use size-coded beads.

The term “detectable response” as used herein refers to an occurrence of, or a change in, a signal that is directly or indirectly detectable either by observation or by instrumentation.

Typically, the detectable response is e.g. an occurrence of a signal wherein the fluorophore is inherently fluorescent and does not produce a change in signal upon binding to a metal ion or biological compound. Alternatively, the detectable response is an optical response resulting in a change in the wavelength distribution patterns or intensity of absorbance or fluorescence or a change in light scatter, fluorescence lifetime, fluorescence polarization, or a combination of the above parameters. Other detectable responses include, for example, bead size, chemiluminescence, phosphorescence, radiation from radioisotopes, magnetic attraction, impedance and electron density.

The present invention is directed to a method of detecting one or more analytes in a bead based assay by using not only one type of magnetic beads but two different types of magnetic beads.

This principle can be applied to many different assay formats like
immuno assays, e.g. sandwich immuno assays
assays based on protein-protein interactions
assays based on enzyme reactions like kinase-assays
assays based on interactions between nucleic acids, like DNA-DNA interactions, DNA-RNA-interactions, RNA-RNA-interactions
assays based on DNA-protein interactions
assays based on peptide-protein or peptide-peptide interactions
assays based on glycan-protein interactions
assays based on metabolite-protein interactions
assays based on metabolite-DNA interactions
assays based on metabolite-RNA interactions

In all cases the analyte is qualitatively or quantitatively, preferably quantitatively, detected or measured by using capture beads and detection beads which are both able to directly or indirectly via an interfering substance bind to the analyte, but to different parts or epitopes of the analyte.

If the protein to be analyzed (analyte) is part of a protein complex composed of a minimum of two different proteins, one of the proteins of the protein complex to be analyzed is captured by its corresponding capture group (e.g. antibody) which is immobilised on capture beads. The detection of the protein(analyte) may take place through incubation with detection beads carrying detection groups directed against the same or one of the other proteins of the protein complex.

In contrast to planar assays in which typically the capture group is immobilised on a solid support like a microtiter plate, the method according to the present invention is directed to a suspension assay in which all components of the assay are either solubilised or suspended in a liquid. This results in totally different binding dynamics compared to planar assays. It has been found that by using the method of the present invention the working time of suspension assays can be significantly reduced—at least to ⅔ of the time compared to known suspension assays using none or only one type of magnetic beads, preferably to ½ of the time compared to known suspension assays using none or only one type of magnetic beads.

According to the method of the present invention, the sample is incubated with the detection and the capture beads, while at least part of the incubation time a magnetic field is applied.

The incubation can be performed with both, capture and detection beads, at the same time.

In one embodiment, the sample is first incubated with one type of beads, that means either the detection beads or the capture beads, preferably the detection beads, without application of a magnetic field. This first incubation allows the analytes to interact with and bind to the first type of beads—in the following description the detection beads are chosen as first type of beads.

Afterwards, the detection beads with the bound analytes are removed from the mixture, e.g. by filtration or preferably by application of a magnetic field.

The beads can optionally be washed to remove unbound sample components. The detection beads are then incubated with the capture beads, whereby at least part of the incubation time a magnetic field is applied. It has been found that applying a magnetic field and thus creating spatial proximity between the two types of magnetic beads, speeds up the time that is needed to create interaction and consequently binding between the analytes and the capture beads.

It has been found that it is also possible to incubate the sample with the capture beads and the detection beads simultaneously and speed up the time that is needed to create interaction and consequently binding between the analytes and the two types of beads.

The bead mixture comprising capture beads and/or detection beads and/or capture beads with bound analyte and/or detection beads with bound analyte and/or analytes with bound capture beads and detection beads can then be removed from the incubation mixture, e.g. by filtration or preferably by applying a magnetic field.

Optionally the bead mixture can be washed one or several times with one or different washing buffers. Washing buffers suitable for use in the present invention are typically aqueous solutions comprising a buffer system e.g. Tris based buffer, phosphate buffer, Citrate buffer, MES, MOPS or HEPES, preferably Tris based, phosphate buffer. The washing buffer may also comprise salts like NaCl, KCl, etc., preferred is NaCl. The pH of the washing buffer is typically between pH 6 and pH 8, preferred is a pH between 7.2 and 7.5.

The washing buffer may also comprise additives like detergents e.g. Tween®20, Triton® X100 or Brij, preferred is Tween®20, in a concentration range between 0.01-1% (by weight), preferably 0.01-0.1%.

The buffer may also comprise solvents like ethanol or DMSO in concentrations that do not destroy the magnetic beads.

If the detection beads do not directly give a detectable signal or response, the bead mixture is then incubated with reagents that induce a detectable response.

The bead mixture is then analysed to detect and/or measure the presence of the analyte. The read out is typically performed by flow cytometry, in a microscope, enzymatically in an ELISA reader or by impedance, preferably by flow cytometry.

In a preferred embodiment, the capture groups and the detection groups which are bound to the capture beads and the detection beads respectively are two different types of antibodies which bind to different epitopes of an analyte. In a preferred embodiment, the capture bead comprises an antibody specifically binding to the analyte of interest, i.e., the analyte to be detected in a sample. Other useful capture groups are molecules to which the analyte of interest has an affinity, i.e. to which it binds. In a preferred embodiment, the detection bead comprises an antibody specifically binding to the analyte of interest. It will be appreciated that an antibody identified herein which is useful as a capture group is also useful as a detection group, and vice versa. The detection antibody and the capture antibody have to be chosen in a way that binding of a capture antibody will not interfere with the binding of a detection antibody.

Consequently, the present invention preferably provides for a detection bead comprising a detection group which binds to the same analyte as the capture group of the capture bead, albeit to a non-overlapping epitope on the analyte, thereby allowing both capture group and detection group to bind to the same analyte.

As antibodies are preferred detection and capture groups, consequently, in one aspect, the invention provides a method for detecting an analyte in a sample, the method comprises the steps of
contacting a sample with detection beads carrying a first antibody which specifically binds to the analyte thereby forming a first antibody/analyte complex
contacting the first antibody/analyte complex with capture beads carrying a second antibody specifically binding the analyte, whereby at least part of the incubation time a magnetic filed is applied, thereby forming a first antibody/ analyte/second antibody complex,
detecting the detectable signal which is directly or indirectly produced by the detection beads and thereby detecting the analyte in the sample.

The detection bead may comprise various labels. Preferably, the bead and/or the capture group carry one or more detectable labels. A preferred label is a fluorochrome. Preferably, the detection group of the detection bead is an antibody which is labeled with a fluorochrome. In some embodiments, the fluorochrome is phycoerythrin.

The capture bead preferably is a magnetic and fluorescent bead. In some embodiments, the capture bead is a ferromagnetic bead. In some embodiments, the capture bead is a ferromagnetic and fluorescent bead with one or more different fluorescent labels. In some embodiments, the capture bead is a magnetic Luminex® bead.

Typically when using Luminex® beads, each bead set is coated with a reagent specific to a particular analyte, allowing the capture and detection of specific analytes from a sample. Within the Luminex® compact analyzer, lasers excite the internal dyes that identify each bead, and also any reporter dye captured during the assay. Many readings are made on each bead set, further validating the results. In this way, xMAP® technology allows multiplexing of up to 100 unique assays within a single sample, both rapidly and precisely.

Detection

In some embodiments, the invention provides methods and compositions that include labels for the highly sensitive detection and quantification of an analyte, e.g., of an antigen in a sample. In some embodiments of the present invention, the detection group or the detection bead comprises a label. In some embodiments of the present invention, the detection bead generates a detectable signal. In some embodiments of the present invention, the detection group is an antibody which comprises a label. In some embodiments of the present invention, the detection group is an antibody which generates a detectable signal.

This signal-generating detection group, such as a second antibody, comprises a compound or “label” which is in itself detectable or may be reacted with one or more additional compounds to generate a detectable product or detectable signal. Examples of signal-generating compounds include chromogens, radioisotopes, chemiluminescent compounds (e.g., acridinium), particles (visible or fluorescent), nucleic acids, complexing agents, or catalysts such as enzymes (e.g., luciferase, alkaline phosphatase, acid phosphatase, horseradish peroxidase, beta-galactosidase and ribonuclease).

(1) Fluorescent Moieties

A preferred label is a fluorescent moiety, also referred to herein as a fluorochrome.

In some embodiments, a fluorescent moiety is attached to the detection bead or the detection group. The compositions and methods of the invention may utilize highly fluorescent moieties wherein the fluorescent moiety is capable of emitting photons when stimulated by a laser emitting light at the excitation wavelength of the moiety.

In some embodiments, the fluorescent moiety comprises an average of at least about 1, 2, 3, 4, 5, 6, 7, 8, 9, or 10 fluorescent entities, e.g., fluorescent molecules. In some embodiments, the moiety comprises a plurality of fluorescent entities, e.g., about 2-4, 2-5, 2-6, 2-7, 2-8, 2-9, 2-10, or 3-5, 3-6, 3-7, 3-8, 3-9, or 3-10 fluorescent entities.

In some embodiments, the moiety comprises one fluorescent entity.

The fluorescence generated by the fluorescent moiety is dependent upon the presence, absence or concentration of the analyte. Examples of suitable fluorescent moieties include rhodamine 110; rhodol; coumarin or a fluorescein compound.

In some embodiments of the present invention, a fluorescent entity is a fluorescent dye molecule. The following provides a non-inclusive list of useful fluorescent dyes for use as fluorescent moieties: Bimane, Dapoxyl, Dimethylamino coumarin-4-acetic acid, Marina blue, 8-Anilino naphthalene-1-sulfonic acid, Cascade blue, Alexa Fluor 405, Cascade blue, Cascade yellow, Pacific blue, PyMPO, Alexa 430, Atto-425, NBD, Alexa 488, Fluorescein, Oregon Green 488, Atto 495, Cy2, DY-480-XL, DY-485-XL, DY-490-XL, DY-500-XL, DY-520-XL, Alexa Fluor 532, BODIPY 530/550, 6-HEX, 6-JOE, Rhodamine 6G, Atto-520, Cy3B, Alexa Fluor 610, Alexa Fluor 633, Alexa Fluor 647, BODIPY 630/650, Cy5, Alexa Fluor 660, Alexa Fluor 680, Alexa Fluor 700, Alexa Fluor, B-phycoerythrin, R- phycoerythrin, Allophycocyanin, PBXL-I, PBXL-3, Atto 425, Atto 495, Atto 520, Atto 560, Atto 590, Atto 610, Atto 655, Atto 680, DY-495/5, DY-495/6, DY-495X/5, DY-495X/6, DY- 505/5, DY-505/6, DY-505X/5, DY-505X/6, DY-550, DY-555, DY-610, DY-615, DY-630, DY-631, DY-633, DY-635, DY-636, DY-650, DY-651, DYQ-660, DYQ-661, DY-675, DY-676, DY-680, DY-681, DY-700, DY-701, DY-730, DY-731, DY-750, DY-751, DY-776, DY-780-OH, DY-780-P, DY-781, DY-782 , EVOblue-10, and EVOblue-30. Either one of these individual dyes or combinations thereof may be used as a fluorescent moiety. A detailed characterization of these dyes can be found in US2006/0078998 and US2008/00641 13, which are herein incorporated by reference in their entirety.

In some embodiments, a fluorescent entity comprises a first type and a second type of dye molecule, e.g, where the first type and second type of dye molecules have different emission spectra. The ratio of the number of first type to second type of dye molecule may be, e.g., 4:1, 3:1, 2:1, 1:1, 1:2, 1:3 or 1:4. The binding partner may be, e.g., a polypeptide.

A preferred fluorescent dye is R-phycoerythrin.

In some embodiments of the present invention, a fluorescent entity is a quantum dot. Thus, in some embodiments, the fluorescent label moiety that is used to detect an analyte in a sample is a quantum dot. Quantum dots (QDs), also known as semiconductor nanocrystals or artificial atoms, are semiconductor crystals that contain anywhere between 100 to 1,000 electrons and range from 2-10 nm. Some QDs can be between 10-20 nm in diameter. QDs have high quantum yields, which makes them particularly useful for optical applications.

QDs are fluorophores that fluoresce by forming excitons, which can be thought of the excited state of traditional fluorophores, but have much longer lifetimes of up to 200 nanoseconds.

This property provides QDs with low photobleaching. The energy level of QDs can be controlled by changing the size and shape of the QD, and the depth of the QDs' potential.

QDs can be coupled to streptavidin directly through a maleimide ester coupling reaction or to antibodies through a maleimide-thiol coupling reaction. This yields a material with a biomolecule covalently attached on the surface, which produces conjugates with high specific activity. In some embodiments, the protein that is detected is labeled with one quantum dot.

In some embodiments the quantum dot is between 10 and 20 nm in diameter. In other embodiments, the quantum dot is between 2 and 10 nm in diameter.

One skilled in the art will recognize that many strategies and a variety of suitable means can be used for the attachment of a fluorescent moiety, or fluorescent entities that make up the fluorescent moiety, to a detection group or a detection bead. The label may be attached by any known means, including methods that utilize non-specific or specific interactions of label and target. The label might be attached to the detection group and/or the detection bead. Preferably it is attached to the detection bead.

Labelling can be accomplished directly or through binding partners.

Beads

Beads for use in the present invention can vary widely. A bead can be porous or nonporous. It can be symmetrically shaped or irregularly shaped. A bead can be made of a variety of materials including ceramics, glass, other inorganic materials like metal oxides, metals, organic polymeric materials, or combinations thereof.

The beads to be used as capture or detection beads in the present invention are magnetic beads. Preferred magnetic beads are paramagnetic, superparamagnetic, ferrimagnetic or ferromagnetic beads. Magnetic beads, typically, comprise a magnetic oxide particle, such as magnetic iron oxide, maghemite, magnetite, or manganese zinc ferrite. The magnetic material may be constituted of very fine particles of mineral oxides with paramagnetic properties such as magnetite (a mixed iron oxide), hematite (an iron oxide), chromite (a salt of iron and chrome) and all other material attracted by a permanent magnet or electromagnet. Also ferrites such as iron tritetraoxide (Fe₃O₄), γ-sesquioxide (γ-Fe₂O₃), MnZn-ferrite, NiZn-ferrite, YFe-garnet, GaFe-garnet, Ba-ferrite, and Sr-ferrite; metals such as iron, manganese, cobalt, nickel, and chromium; alloys of iron, manganese, cobalt, nickel, and the like, but not limited thereto, can be used. The preferred material is magnetite because of its availability and low cost. It is supplied as particles of different size, dry or as an aqueous stabilized suspension.

The magnetic beads according to the present invention typically have a magnetic core which is partly or totally covered by at least one coating, e.g. a silica coating, a coating with one or more other metal oxides like Al₂O₃, titanium dioxide, zirconium dioxide, or an organic polymer coating, e.g. a coating made of polystyrole, polymethacrylate, polyvinylalcohol, polysiloxan, or a coating made of a natural material like dextrane or chitosan. For the coupling of detection or capture groups or labels, the beads can be further modified with reactive groups, charged groups or other functional groups.

It is also possible to use magnetic beads which are made of non-magnetic materials including ceramics, glass, other inorganic materials like metal oxides, metals, organic polymeric materials, or combinations thereof in which one or more magnetic particles are incorporated.

Preferably, the capture beads are magnetic polystyrene beads.

The diameter of the capture beads is typically between 0.5 μm and 50 μm, preferably between 1 and 10 μm.

Preferably the capture beads are magnetic Luminex® beads, e.g. polystyrene based magnetic beads with a diameter of 6.5 μm. This technology is further described in U.S. Pat. No. 6,268,222, incorporated herewith by reference in its entirety.

The detection beads and the capture beads may have the same or different diameters. They may also comprise the same or different materials.

Typically the capture beads have a larger diameter than the detection beads.

Typically, the detection beads have diameters between 1 nm and 1 μm. Preferably, the detection beads have diameters between 20 and 50 nm, most preferred about 21, 22, 23, 24, 25, 26, 27, 28, 29, 30, 31, 32, 33, 34 or 35 nm.

Preferably, the detection beads carry more than one label. The label and the detection group can be attached or conjugated to the bead e.g. via reactive groups like —COON, amine, epoxy or activated ester functions or via a binding system like an avidin/biotin binding system. The labels can also be attached to the detection groups of the detection beads.

Typically, the detection beads carry one or more detection groups and more than one label.

Typically, the amount of detection beads used in an assay according to the present invention is larger than the amount of capture beads.

Assay Performance

To perform the method of the present invention, one has to provide a sample solution, i.e. a solution comprising the sample to be analyzed.

Typically the sample solution is an aqueous solution. It may also comprise buffers like Tris based buffer, phosphate buffer, Citrate buffer, MES, MOPS, HEPES, preferred is Tris based buffer. The sample solution may also comprise salts like NaCl, KCl, etc., preferred is NaCl. The pH of the sample solution typically is between pH 6 and pH 8, preferably it is between pH 7.2 and 7.5. The sample solution may also comprise additives like detergents e.g. Tween® 20, Triton® X100 or Brij, preferably Tween®20, in concentrations between 0.01 and 1% (per weight), preferably between 0.01 and 0.1%. The sample solution may also comprise additives like proteins e.g. Gelatine, BSA in concentrations between 0.01 and 2% (per weight), preferably between 0.1 and 1.5%. The sample solution may also comprise solvents like ethanol, DMSO in concentrations that do not destroy the magnetic beads.

Additional assay components are the magnetic capture beads carrying capture groups and the magnetic detection beads carrying detection groups.

The sample solution is then incubated with the capture beads and the detection beads whereby at least during a part of the incubation time a magnetic field is applied.

Preferably, both types of beads are added to the sample solution simultaneously. But it is also possible that a sequential incubation is performed. That means one type of beads, either the capture beads or the detection beads, is pre-incubated with the sample solution. After the pre-incubation the second type of beads is added.

If both beads are added simultaneously, the incubation of the two types of beads with the sample solution typically takes about 5 minutes to 1 hour, preferably about 5 to 15 minutes, whereby at least during a part of the incubation time a magnetic field is applied. A magnetic field could be applied during the whole time when the two types of beads are incubated with the sample solution. Preferably, the magnetic field is applied during only a part of the incubation time. Most preferred, the magnetic is applied sequentially or in cycles. That means, the magnetic field is applied for 2 to 10 times, preferably for 3 to 5 times during the incubation. During the time in which the magnetic field is turned off, the sample can be mixed or shaken if necessary.

When performing sequential incubation, the pre-incubation of the sample solution with the first type of beads typically takes about 10 minutes to 2 hours. Pre-incubation can be supported by thoroughly mixing the sample solution and the beads, e.g. by shaking.

In a preferred embodiment, after the pre-incubation with one type of beads, these beads are isolated from the sample solution, e.g. by filtration or by applying a magnetic field. Depending on the sample solution, if necessary, the beads can be washed one or several times with one or several washing buffers to remove unbound residues of the sample solution from the beads.

The isolated beads are then incubated with the second type of beads in a new incubation solution. The incubation solution typically is an aqueous solution and may comprise the same constituents (buffer, salts etc.) as the sample solution.

The second incubation of the two types of beads typically takes about 5 minutes to 1 hour, preferably about 5 to 15 minutes, whereby at least during a part of the incubation time a magnetic field is applied. Preferably, a magnetic field is applied during the whole time when the two types of beads are incubated together.

It was found, that by using two types of magnetic beads in one assay and by applying a magnetic field least during a part of the time when the two types of beads are incubated together, the incubation time can be significantly reduced.

The application of a magnetic filed can e.g. be realized by applying an external magnetic field which makes all magnetic beads in the solution move to one side or the bottom of the container in which the incubation takes place. It can also be done by dipping a magnetic device like a magnetic stick, e.g. a magnetic bead handler, into the incubation solution so that all magnetic beads are collected at the device. A suitable device is for example a kingfisher® (Thermo Fisher Scientific).

All incubation steps are typically performed at room temperature.

It has been further found that when performing a sequential incubation the incubation time of the pre-incubation step can be reduced if the sample solution is first incubated with the smaller type of beads, i.e. typically the detection beads.

As a consequence, in a preferred embodiment of the sequential incubation, in a first step, the sample solution is incubated with the detection beads so that the analyte is bound to the detection beads. After removing the detection beads with the bound analyte from the mixture they are incubated with the capture beads whereby at least during a part of the incubation time a magnetic field is applied.

A person skilled in the art of bead based assays is easily able to determine the suitable amount of capture beads and detection beads that is added to the sample solution or incubation solution.

The capture beads need to be added in excess so that it is made sure that all analytes present in the sample can bind to capture beads.

The ideal concentration of the magnetic detection beads must be experimentally determined. The concentration depends on properties of the detection groups immobilized on the beads, e.g. affinity. For that purpose the number/amount of beads has to be titrated. In general an optimal concentration of the beads is determined if the optimal signal to noise ratio is reached. A typical concentration for the application of the magnetic detection beads is 1.25 μg beads per ml assay volume.

After the incubation, the beads can optionally be washed one or several times with one or several washing buffers but typically no washing step is needed.

In one embodiment of the present invention, the method of the present invention is performed in a multiplexed assay format. That means the method is directed to the detection of not only one but more than one, typically between 2 and 500, e.g. 2, 3, 4, 5, 6, 7, 8, 9, 10, 11, 12, 13, 14, 15, 16, 17, 18, 19 or 20 different analytes. The assay is performed in the same way as described before for the detection of one analyte, the difference being the types of beads that are used.

If the detection bead that is used is carrying detection groups that are able to bind to all analytes to be detected, it is sufficient to use one type of detection beads. Nevertheless, it is also possible to use more than one type of detection beads, whereby the different types of detection beads carry different detection groups which can bind to different analytes. The labels of the detection beads may be the same or different. Preferably, all detection beads in one assay, either a single or a multiplexed assay, carry the same label.

In a multiplexed assay format, different types of capture beads are used. Typically, each type of capture bead can bind to one type of analyte so that having performed the incubation, one type of analyte is bound to one type of capture bead and another type of analyte is bound to another type of capture bead. As said before, the detection beads bound to the different analytes may be the same or different.

In a last step the presence of analytes which are bound to at least one capture bead and at least one detection bead is detected.

Preferably, the detection is done quantitatively.

Detection can be performed in any detector which is able to differentiate between unbound beads and analytes which are bound to at least one capture bead and at least one detection bead. The type of detector depends on the type of label that shall be detected. Especially for multiplexed assay formats, not only the detection beads but also the capture beads are labelled so that one can differentiate between different capture beads with affinity to different analytes.

In a preferred embodiment, the detection is done in a detector suitable for Luminex xMAP® technology. That means this detector is able to detect the capture beads labelled with two different fluorescent dyes and the detection bead labelled with a third fluorescent dye, e.g. phycoerythrin.

The fluorescence of the detection bead is an indicator for the binding of the analyte to the capture bead and the detection bead.

In a very preferred embodiment, detection is done by flow cytometry.

The present invention is also directed to a kit comprising at least a set comprising magnetic capture beads carrying capture groups and magnetic detection beads carrying detection groups whereby the capture groups and the detection groups are able to bind directly or indirectly to the same analyte. The kit may also comprise additional components like standards, lysis buffers or reagents for internal control.

In one embodiment the kit comprises more than one set comprising magnetic capture beads carrying capture groups and magnetic detection beads carrying detection groups whereby the capture groups and the detection groups of different sets bind to different analytes. This kit is suitable for performing multiplexed assays.

The kit and the method according to the present invention offer the possibility to detect analytes in assay formats that are easy to handle, that can be automatized and that can be performed in a multiplexed format. The sensitivity of the analysis is at least equal to known assay formats in which only the capture bead is a magnetic bead.

The entire disclosures of all applications, patents, and publications cited above and below and of corresponding EP application EP 10007645.4, filed Jul. 23, 2010, are hereby incorporated by reference.

### EXAMPLES

1) Working Procedure for Sequential Incubation

Detection beads, e.g. magnetic and fluorescent nanoBeads (25 nm), that are coated with an analyte specific antibody, are incubated with a sample solution for typically <1 h. Then the detection beads are collected e.g. with a magnetic bead handler and transferred to a second solution with magnetic capture beads (6.5 μm) which are coated with analyte specific antibody as well. The binding of the analyte (which is already bound to the detection beads) to the capture beads is magnetically assisted and done in less than 10 minutes. Afterwards the detection/read out can be performed e.g. by flow cytometry.

2) Detection of Her2

Her2 is incubated at different concentrations (10000, 2500, 625, 156, 39, 10 and 2,4 pg/mL) with 12,5 ng magnetic and fluorescent magnetic beads with 25 nm diameter coated with anti-Her2 antibody for 1 h. Then the beads are transferred to 1000 magnetic Luminex®-Beads with a diameter of 6.5 μm that are coated with another anti-Her2 antibody and incubated for 10 min.

Finally the bound Her2 is quantified in a Luminex® reader.

FIG. 2 shows the curve of the Her2 detection.

3) Multiplex Detection of 5 RTKs (Receptor Tyrosine Kinases)

RTKs are incubated at different concentrations with 12.5 ng magnetic and fluorescent nanoBeads (5 different populations with antibodies against each RTK) for 1 h. Then nanoBeads are transferred to color-coded Luminex®-Beads that are coated with another anti-RTK specific antibody (also 5 populations and 1000 Beads of each population) and incubated for 10 min. Finally the bound RTKs are quantified in a Luminex® reader.

The results of this detection can be found in the following table as well as in FIG. 3.

| | | EGFR | HGFR | PDGFR beta | HER 2 | VEGFR 2 |
|---|---|---|---|---|---|---|
| | | MFI | MFI | MFI | MFI | MFI |
| x-fold | 1 | 942 | 7699 | 3171 | 2438 | 9416 |
| dilution of | 4 | 266 | 2204 | 883 | 676 | 4557 |
| the | 16 | 80 | 613 | 438 | 460 | 1543 |
| standards | 64 | 24 | 71 | 135 | 142 | 179 |
| | 256 | 17 | 23 | 46 | 50 | 28 |
| | 1024 | 10 | 10 | 27 | 26 | 12 |
| | 4096 | 12 | 8 | 26 | 17 | 10 |
| | Blank | 9 | 6 | 17 | 12 | 6 |

| | | | | | |
|---|---|---|---|---|---|
| 1-fold dilution | 10000 | 25000 | 10000 | 10000 | 50000 |
| [pg/mL] | | | | | |

4) Influence of Magnetic Force on the Magnetic Nano-Bead/Micro-Bead Assay

Her2 is incubated at different concentrations (2000, 1000, 500, 250, 125, 62 and 31 pg/mL) with 12,5 ng magnetic and fluorescent magnetic beads with 25 nm diameter coated with anti-Her2 antibody and magnetic Luminex®-Beads with a diameter of 6.5 μm that are coated with another anti-Her2 antibody for 20 min. During incubation beads are brought in close contact by magnetic force. The same assay is also performed without magnetic force. Low or no signal is obtained if no magnetic force is applied in the assay. Therefore increased assay speed can be clearly assigned to the magnetic force. The results of this experiment are shown in FIG. 4.

1. A method of detecting an analyte by
a) providing a sample solution, magnetic capture beads carrying capture groups and magnetic detection beads carrying detection groups;
b) incubating the sample solution with the capture beads and the detection beads whereby at least during a part of the incubation time a magnetic field is applied;
c) detecting the presence of analytes which are directly or indirectly bound to at least one capture bead and at least one detection bead.

2. Method according to claim 1, characterized in that the capture groups and the detection groups are antibodies.

3. Method according to claim 1, characterized in that step b) is performed by
b1) incubating the sample solution with the detection beads so that the analyte is bound to the detection beads
b2) removing the detection beads from the mixture of b1) and incubating the detection beads comprising the bound analyte with the capture beads whereby at least during a part of the incubation time a magnetic field is applied.

4. Method according to claim 1, characterized in that in step b) the capture beads and the detection beads are simultaneously incubated with the sample solution.

5. Method according to claim 1, characterized in that in step a) more than one type of magnetic capture beads are used whereby each type of magnetic capture beads binds to another analyte.

6. Method according to claim 1, characterized in that the magnetic field is applied by dipping a magnetic device in the sample solution.

7. Method according to claim 1, characterized in that step c) is done by flow cytometry analysis.

8. Method according to claim 1,l characterized in that the capture beads are ferromagnetic beads which are labelled with two different fluorescent dyes.

9. Kit comprising at least one set comprising magnetic capture beads carrying capture groups and magnetic detection beads carrying detection groups whereby the capture groups and the detection groups are able to bind directly or indirectly to the same analyte.

10. Kit according to claim 9 characterized in that the kit comprises more than one set comprising magnetic capture beads carrying capture groups and magnetic detection beads carrying detection groups whereby the capture groups and the detection groups of different sets bind directly or indirectly to different analytes.
